(19) United States
(12) Patent Application Publication
(10) Pub. No.: US 2013/0302478 A1
(43) Pub. Date: Nov. 14, 2013

(54) PACKAGED FOOD PRODUCTS AND RELATED METHODS

(71) Applicant: GENERAL MILLS, INC., Minneapolis, MN (US)

(72) Inventors: Stephen P. ANDERSON, New Hope, MN (US); Michael P. BASHOR, Plymouth, MN (US); Scott F. GILLESPIE, Maple Grove, MN (US)

(73) Assignee: GENERAL MILLS, INC., Minneapolis, MN (US)

(21) Appl. No.: 13/875,658

(22) Filed: May 2, 2013

Related U.S. Application Data
(60) Provisional application No. 61/644,354, filed on May 8, 2012.

(51) Int. Cl. A23C 9/123

(52) U.S. Cl. CPC A23C 9/123
USPC 426/115

(57) ABSTRACT

In accordance with an exemplary embodiment of the present teachings, a food product may comprise an elongated, flexible-wall tube package. The food product may further comprise a first viscous foodstuff disposed within the tube; and a second viscous foodstuff disposed within the tube, the second viscous foodstuff differing from the first viscous foodstuff. The first and second viscous foodstuffs may be disposed within the tube in two layers in direct contact with each other.

This application claims the benefit of U.S. Provisional Application No. 61/644,354, filed May 8, 2012, which is incorporated by reference herein in its entirety.

### TECHNICAL FIELD

The present disclosure relates generally to packaged food products and systems and methods for packaging food products. More particularly, the present disclosure relates to food products including viscous foodstuffs packaged in flexible-wall tubes, such as for example, cultured or fermented dairy products such as yogurt, and related systems and methods.

### BACKGROUND

The section headings used herein are for organizational purposes only and are not to be construed as limiting the subject matter described in any way.

To enhance the appeal and marketability of a food product beyond the food material itself, food manufacturers often attempt to present traditional food products in interesting and different packaging and/or arrangements. As an example, yogurt has been packaged in flexible-wall tubes, which can be conveniently consumed without the use of a spoon by cutting and/or tearing the end of the tube and squeezing the yogurt from the tube directly into the consumer's mouth. By virtue of not requiring a spoon for consumption, the food product is more acceptable to many consumers for consumption away from the home, such as, for example, for work and/or school lunches. Additionally, flexible-wall tubes containing yogurt can lend themselves to greater portability than conventional relatively rigid-wall yogurt cups, which generally also require a spoon for consumption. Furthermore, yogurt tubes add a play value during the consumption of the yogurt, which has been found to enhance the marketability of the product to younger consumers.

Although yogurt-filled, flexible-wall tubes have experienced considerable market success, there is a continued need to present yogurt and similar viscous foodstuffs in new arrangements to refresh the product and enhance its marketability. It may be desirable therefore to provide new arrangements and types of the foodstuff within such flexible-wall tubes.

Various difficulties arise, however, when attempting to load viscous foodstuff, such as a yogurt, into such flexible-wall tube packaging, as opposed to relatively rigid-wall cup packaging. A cup, for example, may be positioned at various filling stations relatively easily, for example, at which different colors and/or flavors of yogurt may be loaded. Flexible-wall tubes, however, can pose difficulties in attempting to load them with foodstuff. For example, it may be difficult to move such a container between differing filling stations. It may be desirable, therefore, to provide an efficient method of producing such flexible-wall tube food products.

### SUMMARY

The present disclosure may solve one or more of the above-mentioned problems and/or achieve one or more of the above-mentioned desirable features. Other features and/or advantages may become apparent from the description which follows.

In accordance with an exemplary embodiment of the present teachings, a food product may comprise an elongated, flexible-wall tube package. The food product may further comprise a first viscous foodstuff disposed within the tube; and a second viscous foodstuff disposed within the tube, the second viscous foodstuff differing from the first viscous foodstuff. The first and second viscous foodstuffs may be disposed within the tube in two layers in direct contact with each other.

Additional objects and advantages will be set forth in part in the description which follows, and in part will be obvious from the description, or may be learned by practice of the present teachings. At least some of the objects and advantages of the present disclosure may be realized and attained by means of the elements and combinations particularly pointed out in the appended claims.

It is to be understood that both the foregoing general description and the following detailed description are exemplary and explanatory only and are not restrictive of the invention, as claimed. It should be understood that the invention, in its broadest sense, could be practiced without having one or more features of these exemplary aspects and embodiments.

### BRIEF DESCRIPTION OF DRAWINGS

The accompanying drawings, which are incorporated in and constitute a part of this specification, illustrate some exemplary embodiments of the present disclosure and together with the description, serve to explain certain principles. In the drawings,

FIG. 1 is a front view of an exemplary embodiment of a food product including a flexible-wall tube in a closed configuration in accordance with the present disclosure;

FIG. 2 is a top view of the food product of FIG. 1;

FIG. 3 is a cross-sectional view of the food product of FIG. 1 taken through line 3-3 of FIG. 2;

FIG. 4 is a front view of the food product of FIG. 1 in an open configuration showing foodstuff being dispensed;

FIG. 5 is a top view of the food product of FIG. 1 in an open configuration;

FIG. 6 is a cross-sectional view of another exemplary embodiment of a packaged food product in accordance with the present disclosure;

FIG. 7 is a cross-sectional view of another exemplary embodiment of a packaged food product in accordance with the present disclosure; and

FIG. 8 is a cross-sectional view of another exemplary embodiment of a packaged food product in accordance with the present disclosure.

### DESCRIPTION OF EXEMPLARY EMBODIMENTS

Reference will now be made in detail to various exemplary embodiments of the present teachings, examples of which are illustrated in the accompanying drawings. Wherever possible, the same reference numbers will be used throughout the drawings to refer to the same or like parts.

To enhance their appeal and marketability, food products such as yogurt have been marketed in flexible-wall tube packaging, for example, having a generally elongated configuration. Although this packaging concept has experienced considerable market success, there is a continued need to refresh such products and present viscous foodstuffs like yogurt in further novel arrangements, for example, within the packaging itself. To further enhance the appeal and marketability of products such as yogurt, various exemplary embodiments of the present disclosure provide packaged food products with two or more viscous foodstuffs contained in a substantially unmixed arrangement within a single packaging. In various exemplary embodiments, for example, a packaged food product may comprise an elongated, flexible-wall tube containing two or more viscous foodstuffs. In an exemplary embodiment, the viscous foodstuffs may be disposed within the flexible-wall tube in layers that are in direct contact with each other and define an interface therebetween. In at least one exemplary embodiment, the interface lies substantially along an elongate direction (e.g., substantially parallel to or aligned with a longitudinal axis) of the flexible-wall tube. In various embodiments, the two or more viscous foodstuffs may differ from each other. For example, the viscous foodstuffs can have differing characteristics from one another, such as, for example, differing colors, flavors, and/or viscosities to name a few, and/or be of a differing type of foodstuff as explained in more detail below. In various exemplary embodiments, for example, the viscous foodstuffs may comprise two or more differing yogurt phases, each phase comprising a different color and/or flavor of yogurt. In various additional embodiments, the viscous foodstuffs may comprise at least one yogurt and at least one non-yogurt foodstuff, such as, for example, a fruit puree or honey, that is configured to be mixed with or consumed along with the yogurt.

Although various exemplary embodiments herein describe the use of yogurt phases as the packaged foodstuff, those having ordinary skill in the art would appreciate that the principles herein can be applied to a variety of viscous foodstuffs which could be packaged as described in flexible-wall tubes and squeezed therefrom for dispensing. Non-limiting examples of other foodstuffs to which the present teachings can be applied include a variety of fresh dairy products, including but not limited to, for example, cheeses, creams, mousses, dressings, custards, puddings, ice creams, frozen yogurts and the like; gelatins; jellies; butters; fruit preparations or other preparations containing particulates; chocolate or caramel sauces; etc. Further modifications and alternative embodiments to accommodate such foodstuffs would be apparent to those skilled in the art in view of this description.

As used herein the term “flexible-wall tube” refers to a relatively small, elongated, collapsible, metal or plastic package that is sealed at one end and capable of being opened at at least one end (e.g., via a cap, tear-strip, via cutting, or other opening mechanism with which those ordinarily skilled in the art have familiarity) from which a variety of foodstuffs may be dispensed via squeezing the walls to collapse them together. Flexible-wall tubes, for example, have relatively thin, sheet-like walls that may be expanded outwardly and collapsed inwardly without deformation of the walls. Accordingly, the walls of a flexible-wall tube remain collapsed toward each other when the tube is empty and expand outward when the tube's internal volume is filled (e.g., when the tube is loaded with foodstuff). Those having ordinary skill in the art would appreciate that flexible-wall tubes in accordance with the present disclosure may have a variety of cross-sectional configurations, including, for example, square, oval, rectangular, circular triangular, and other polygonal or irregular cross-sectional shapes. Furthermore, the cross-section of a flexible-wall tube may vary along the tube's length, such as, for example, tapering along a length of the tube.

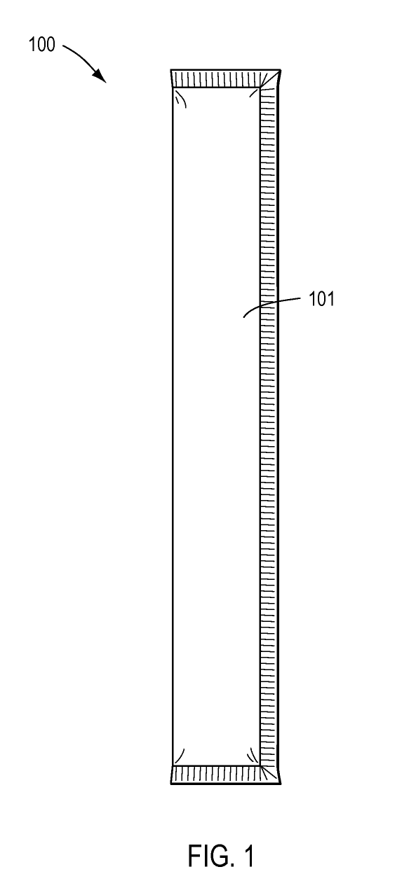

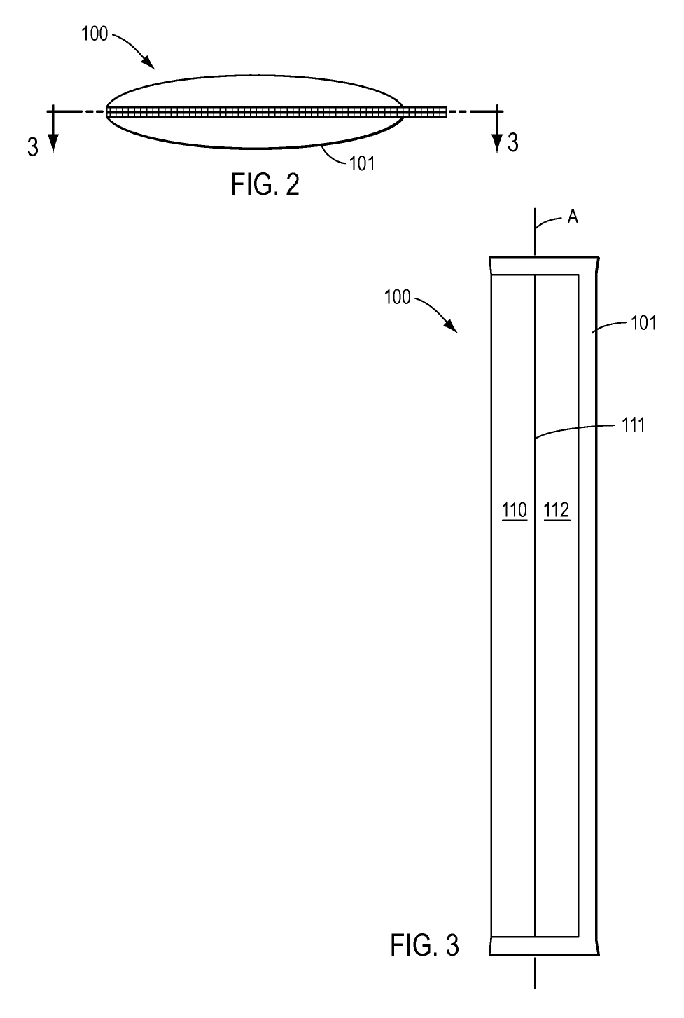

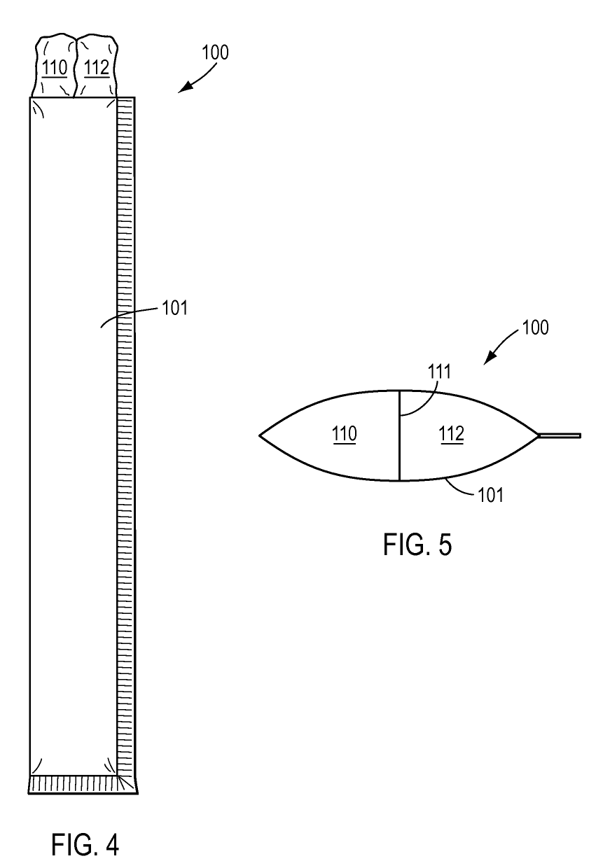

FIGS. 1-5 illustrate an exemplary packaged food product in accordance with the present disclosure. A packaged food product 100 may include an elongated, flexible-wall tube 101 providing a volume sufficient to hold viscous foodstuff for consumption by a consumer. FIGS. 1-3 depict the tube 101 in a closed position (e.g., prior to dispensing of the foodstuff contained therein). FIGS. 4 and 5 depict the tube 101 in an open position (e.g., during dispensing of the foodstuff) with a portion of the foodstuff (depicted at 110 and 112) being dispensed in FIG. 4, for example, via squeezing of the pouch 101.

Those of ordinary skill in the art would understand that the tube 101 depicted in the embodiments of FIGS. 1-5 is exemplary only and that tubes in accordance with the present disclosure may have various configurations, dimensions, and be formed from various flexible-wall materials. By way of example, in various exemplary embodiments, the tube 101 may be formed from a food grade plastic or metal material, which allows for the easy manipulation of the foodstuffs within the tube 101, for example, to permit squeezing the foodstuff from the tube as illustrated in FIG. 4. Those of ordinary skill in the art would further understand that tubes in accordance with the present disclosure may be formed using various techniques and methods. In various exemplary embodiments, for example, the tube 101 may be formed by making use of equipment for vertical, form, fill and seal packaging, such as, for example, disclosed in U.S. Pat. No. 7,128,935 B2 entitled “Method for Making a Patterned Food Product” and issued on Oct. 31, 2006, incorporated by reference herein in its entirety.

As shown in FIGS. 3-5, in various exemplary embodiments of the present disclosure, two viscous foodstuffs 110 and 112 may be disposed within the tube 101. The viscous foodstuffs 110 and 112 may be disposed within the tube 101 in layers in direct contact with each other and define an interface 111 therebetween that lies substantially along the elongated direction (e.g., substantially parallel to or aligned with a longitudinal axis A) of the tube 101 as illustrated in FIG. 3.

In various exemplary embodiments, for example, the viscous foodstuffs may comprise two differing yogurt phases 110 and 112. For example, yogurt phase 110 may comprise a first yogurt color and yogurt phase 112 may comprise a second yogurt color that differs from the first yogurt color. In various embodiments, for example, yogurt phase 110 may comprise a first natural colorant and yogurt phase 112 may comprise a second natural colorant that differs from the first colorant. Useful colorant materials, for example, may include non-bleeding colorants derived from fruits and vegetables, such as, for example, vegetable juices including black carrot juice, and fruit juices including huito juice, beta carotene, turmeric, and/or carmine. As those of ordinary skill in the art would appreciate, however, acceptable colorant materials may also include various artificial colorants including FD&C lake colorants, FD&C water soluble colorants, annatto, and mixtures thereof. Those of ordinary skill in the art would understand how to select from a variety of colorants that are legally permissibly added to yogurt and other foodstuffs.

In various additional embodiments, yogurt phase 110 may comprise a first yogurt flavor and yogurt phase 112 may comprise a second yogurt flavor that differs from the first yogurt flavor. The yogurt phases 110 and 112 also may be of differing flavors and colors. The yogurt phases 110 and 112 may further comprise various combinations, styles and/or types of yogurt.

In various embodiments, for example, the yogurt phases 110 and 112 may each comprise a stirred style yogurt. As used herein the term “stirred style yogurt” refers to a yogurt product in which the yogurt is fermented in bulk prior to filling the packaging tube 101. Thus, a stirred style yogurt typically has a higher viscosity than set style yogurts upon filling due to the lower temperatures and the thickening effect of the yogurt culture. As would be understood by those of ordinary skill in the art, stirred style yogurts come in various styles and product variations, including, for example, “Swiss” style, “Continental” style, “French” style, and variations thereof.

As disclosed in U.S. Pat. No. 6,235,320 B1 entitled “Colored Multi-Layered Yogurt and Methods of Preparation” issued on May 22, 2001, which is incorporated by reference herein in its entirety, there are various difficulties presented by the development of a multi-phase packaged yogurt product, wherein the phases are provided in layers in direct contact with each other and each phase comprises a stirred style yogurt with a visually distinct color. For example, when employing stirred style yogurts, the yogurt phases are liquid and are not set. Thus, the addition of a second yogurt phase (i.e., a second liquid) during packaging may cause the two phases to immediately intermix. This in turn can result in color and/or flavor blending between the phases, depending on the nature of the two differing yogurt phases. Mixing of phases may also arise during the handling of the yogurt-filled flexible-wall tubes, for example, during shipment of the product. Further problems also may be encountered during the extended storage of the yogurt-filled flexible-wall tubes, wherein, for example, one phase may migrate or bleed into the adjacent phase, particularly near the interface, also resulting in interphase mixing of color and/or flavor depending on the types of yogurt phases packaged.

Accordingly, in various embodiments, the yogurt phases 110 and 112 may each comprise a stirred style yogurt exhibiting sufficiently minimal interphase migration (e.g., including sufficiently minimal interphase color and/or flavor bleeding or migration), and increased resistance to interphase mixing. By way of example, minimal color bleeding and migration can be as disclosed in U.S. Pat. No. 6,235,320 B1, incorporated by reference herein in its entirety.

In various exemplary embodiments, the yogurt phases used in conjunction with various exemplary embodiments described herein can comprise a stirred style yogurt that comprises about 8.25% to about 25% milk solids, such as for example, 9% to about 11% milk solids; about 0.5% to about 4% of a modified starch, such as, for example, about 1.5% to about 3.0% of a modified starch; and about 0.1% to about 0.8% of gelatin having a bloom strength of about 200. Furthermore, the yogurt phases can each comprise a stirred style yogurt having a viscosity during the filling of a tube ranging from about 10,000 to about 35,000 centipoise, such as, for example, about 15,000 to about 25,000 centipoise, with a finished viscosity of less than or equal to about 120,000 centipoise. While yogurt is not a perfect Newtonian fluid, viscosity in centipoise is used as a practical tool to measure yogurt thickness as would be understood by those of ordinary skill in the art.

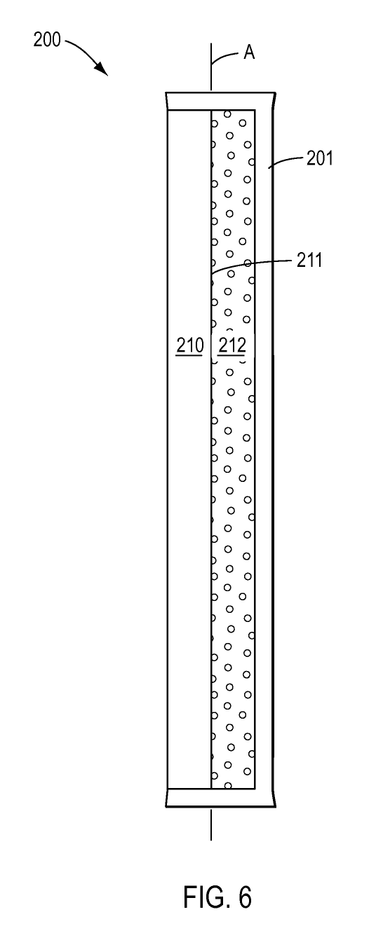

As would be further understood by those of ordinary skill in the art, various types, numbers, configurations, and/or combinations of viscous foodstuffs may be packaged in the manner described above without departing from the scope of the present disclosure. FIG. 6, for example, illustrates another exemplary embodiment of a packaged food product 200 in accordance with the present disclosure. As shown in the cross-sectional view of FIG. 6, as above, two viscous foodstuffs 210 and 212 may be disposed within a flexible-wall tube 201, such that the foodstuffs 210 and 212 are disposed in layers in direct contact with each other and define an interface 211 therebetween that lies substantially in the elongated direction of (e.g., substantially parallel to or aligned with) a longitudinal axis A of the tube 201. The viscous foodstuff 210 may, for example, comprise a yogurt, and the viscous foodstuff 212 may comprise a foodstuff configured to be mixed with or consumed along with the yogurt. In various embodiments, for example, the yogurt 210 may comprise a stirred style yogurt as described above, and the foodstuff 212 may comprise a fruit puree, a honey, or a syrup configured to be mixed with the stirred style yogurt 210. In various exemplary embodiments, viscous foodstuffs in accordance with the present disclosure (i.e., non-yogurt foodstuffs) may have a viscosity during the filling of a tube of less than or equal to about 65,000 centipoise, such as, for example, about 10,000 to about 35,000 centipoise, with a finished viscosity of less than or equal to about 120,000 centipoise

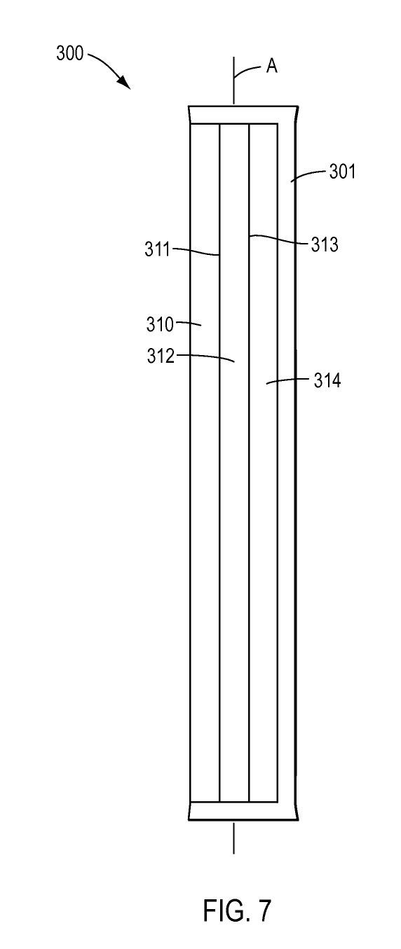

FIG. 7 illustrates yet another exemplary embodiment of a packaged food product 300 in accordance with the present disclosure. As shown in the cross-sectional view of FIG. 7, in various exemplary embodiments, three viscous foodstuffs 310, 312, and 314 may be disposed within a flexible-wall tube 301, such that the viscous foodstuffs 310, 312, and 314 are disposed in layers in direct contact with each other and respectively define interfaces 311 and 313 therebetween that lie substantially along a direction of (e.g., substantially parallel to or aligned with) a longitudinal axis A of the tube 301.

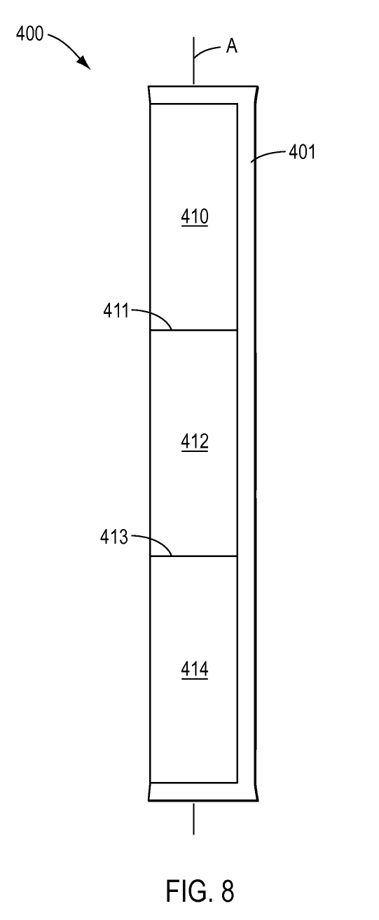

FIG. 8 illustrates a further exemplary embodiment of a food product 400 in accordance with the present disclosure. As shown in the cross-sectional view of FIG. 8, in various exemplary embodiments, three viscous foodstuffs 410, 412, and 414 may be disposed within a flexible-wall tube 401, such that the viscous foodstuffs 410, 412, and 414 are disposed in layers in direct contact with each other and respectively define interfaces 411 and 413 therebetween that are substantially along a direction (e.g., substantially perpendicular to) transverse to a longitudinal axis A of the tube 401.

An exemplary method for producing a packaged food product in accordance with an exemplary embodiment of the present disclosure is set forth in the following description. An elongated, flexible-wall tube 101, 201, 301, 401 can be loaded with a quantity of one or more viscous foodstuffs, e.g., such as 110 and 112, having differing characteristics. In various embodiments, for example, the tube 101, 201, 301, 401 can be loaded with a quantity of differing yogurt phases (e.g., 110 and 112; 310, 312, 314; or 410, 412, 414) or other differing viscous foodstuffs. For example, the flexible-wall tubes in accordance with exemplary embodiments can be loaded with a quantity of two or more differing yogurt colors and/or two or more differing yogurt flavors using production vertical, form, fill and seal equipment.

In an exemplary embodiment, the viscous foodstuffs in the tubes 101, 201, 301, 401 can be loaded into the flexible-wall tubes at a single filling station, such that the viscous foodstuffs are loaded in layers in direct contact with each other within the tubes as described above. In various exemplary embodiments, for example, the viscous foodstuffs can be simultaneously loaded within the tubes 101, 201, 301, 401. In various additional exemplary embodiments the viscous foodstuffs are loaded within the tubes 101, 201, 301, 401 via the same filler tube.

As would be understood by those of ordinary skill in the art, methods in accordance with the present disclosure contemplate loading various types, numbers and/or combinations of viscous foodstuffs, in various quantities and/or configurations, within elongated, flexible-wall tubes. As illustrated in the embodiments depicted in FIGS. 1-7, for example, in various embodiments, the viscous foodstuffs may be substantially vertically loaded (e.g., so as to be disposed in layers extending substantially along the elongated direction of the tubes, sometimes referred to as “neopolitan” style) within the tubes. However, the present disclosure is not limited to such an arrangement and in various additional embodiments, for example as depicted in FIG. 8, the viscous foodstuffs may be substantially horizontally loaded (e.g., so as to be disposed in layers extending substantially transverse to the elongated direction of the tubes, sometimes referred to as “parfait style”) within the tubes. In various further embodiments (not shown), the viscous foodstuffs may be loaded within the tubes in a swirled configuration (e.g., so as to be disposed in layers that twist substantially about the longitudinal axis of the tubes, sometimes referred to as “barber pole” style). In still further embodiments (not shown) the viscous foodstuffs may be loaded within the tubes as concentric rings about a central core (e.g., sometimes referred to as “bull's eye” style). Those of ordinary skill in the art would be able to envision various additional loading configurations based on the exemplary methods of the present disclosure.

It is to be understood that the various embodiments shown and described herein are to be taken as exemplary. Elements and materials, and arrangements of those elements and materials, may be substituted for those illustrated and described herein, and portions may be reversed, all as would be apparent to one skilled in the art after having the benefit of the description herein. Changes may be made in the elements described herein without departing from the spirit and scope of the present disclosure and following claims, including their equivalents.

It is to be understood that the particular examples and embodiments set forth herein are non-limiting, and modifications to structure, dimensions, materials, and methodologies may be made without departing from the scope of the present disclosure.

For the purposes of this specification and appended claims, unless otherwise indicated, all numbers expressing quantities, percentages or proportions, and other numerical values used in the specification and claims, are to be understood as being modified in all instances by the term “about” if they are not already. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

It should be understood that while the present disclosure has been described in detail with respect to various exemplary embodiments thereof, it should not be considered limited to such, as numerous modifications are possible without departing from the broad scope of the appended claims, including the equivalents they encompass.

What is claimed is:

1. A food product comprising:
an elongated, flexible-wall tube package;
a first viscous foodstuff disposed within the tube; and
a second viscous foodstuff disposed within the tube, the second viscous foodstuff differing from the first viscous foodstuff,
wherein the first and second viscous foodstuffs are disposed within the tube in two layers in direct contact with each other.

2. The food product of claim 1, wherein the first viscous foodstuff comprises a first color and the second viscous foodstuff comprises a second color that differs from the first color.

3. The food product of claim 1, wherein the first viscous foodstuff comprises a first yogurt phase and the second viscous foodstuff comprises a second yogurt phase that differs from the first yogurt phase.

4. The food product of claim 3, wherein the first yogurt phase comprises a first yogurt color and the second yogurt phase comprises a second yogurt color that differs from the first yogurt color.

5. The food product of claim 4, wherein the first yogurt phase comprises a first natural colorant and the second yogurt phase comprises a second natural colorant that differs from the first colorant.

6. The food product of claim 3, wherein the first yogurt phase comprises a first yogurt flavor and the second yogurt phase comprises a second yogurt flavor that differs from the first yogurt flavor.

7. The food product of claim 3, wherein each of the first and second yogurt phases is a stirred style yogurt phase.

8. The food product of claim 3, wherein each of the first and second yogurt phases comprises:
from about 8.5% to about 25% milk solids;
from about 0.5% to about 4.0% of a modified starch; and
from about 0.1% to about 0.8% of gelatin having a bloom strength of about 200.

9. The food product of claim 8, wherein each of the first and second yogurt phases comprises:
from about 9.0% to about 11% milk solids;
from about 1.5% to about 3.0% of a modified starch; and
from about 0.1% to about 0.8% of gelatin having a bloom strength of about 200.

10. The food product of claim 1, wherein each of the first and second foodstuffs has a viscosity ranging from about 10,000 to about 35,000 centipoise.

11. The food product of claim 10, wherein each of the first and second foodstuffs has a viscosity ranging from about 15,000 to about 25,000 centipoise.

12. The food product of claim 1, wherein each of the first and second foodstuffs has a finished viscosity of less than or equal to about 120,000 centipoise.

13. The food product of claim 1, wherein the first viscous foodstuff comprises a yogurt and the second viscous foodstuff comprises a foodstuff configured to be mixed with or consumed along with the yogurt.

14. The food product of claim 13, wherein the yogurt comprises a stirred style yogurt.

15. The food product of claim 14, wherein the second viscous foodstuff is chosen from a fruit puree, a honey, and a syrup.

16. The food product of claim 1, further comprising a third viscous foodstuff disposed within the tube in a third layer in direct contact with the second viscous foodstuff, the third viscous foodstuff differing from the first and second viscous foodstuffs.

17. The food product of claim 1, wherein the layers define an interface therebetween that lies substantially in a direction of elongation of the tube.

18. The food product of claim 1, wherein the layers define an interface therebetween that lies substantially transverse to a direction of elongation of the tube.
